(19) United States
(12) Patent Application Publication
(10) Pub. No.: US 2013/0219511 A1
(43) Pub. Date: Aug. 22, 2013

(54) Methods, Media, and Systems for Monitoring Access to Computer Environments

(71) Applicants: Marc Christian Fielding, Ottawa (CA); Paul Vallee, Ottawa (CA); Darrin Leboeuf, Ottawa (CA); Darren Richard Kipp, Ottawa (CA); Alexander Gorbachev, Orleans (CA)

(72) Inventors: Marc Christian Fielding, Ottawa (CA); Paul Vallee, Ottawa (CA); Darrin Leboeuf, Ottawa (CA); Darren Richard Kipp, Ottawa (CA); Alexander Gorbachev, Orleans (CA)

(21) Appl. No.: 13/843,672

(22) Filed: Mar. 15, 2013

Related U.S. Application Data
(63) Continuation of application No. 13/306,742, filed on Nov. 29, 2011.

(51) Int. Cl. H04L 29/06

(52) U.S. Cl. CPC H04L 63/10
USPC 726/27

(57) ABSTRACT

Method, media, and systems for monitoring access to computer environments are provided. Methods for monitoring access to a computer environment by a technician workstation are provided, the methods comprising: setting tip a remote desktop access session between a hardware processor of a proxy and the technician workstation; connecting the remote desktop access session to the computer environment; providing access to the computer environment from the technician workstation using the remote desktop access session; recording remote desktop access messages; and replaying the remote desktop access messages.

### CROSS-REFERENCE TO RELATED APPLICATIONS

This is a continuation application of U.S. patent application Ser. No. 13/306,742, filed Nov. 29, 2011 which is hereby incorporated by reference herein in its entirety.

### TECHNICAL FIELD

Methods, media, and systems for monitoring access to computer environments are provided.

BACKGROUND

Security concerns about data and programs stored in computer environments, such as computer data centers, physical or virtual infrastraeture(s) hosting sensitive data or processes that require special monitoring and control capabilities, and/or any other suitable computer environments), are of ever-increasing importance in information technology communities. Recent breaches of security of credit card, hank account, and social security numbers from such computer environments, and consequent economic losses, has renewed demands for tighter restrictions on access and monitoring of such environments.

While concerns about unauthorized activities of persons with no authorized access (which can be referred to as “outsiders”) to such computer environments are always a concern, increasingly owners of such environments are similarly concerned about unauthorized activities of persons with authorized access (which can be referred to as “insiders”) to the environments. For example, owners axe concerned that an unhappy employee may sabotage data and/or programs stored in a computer environment. As another example, owners are concerned that an employee may attempt to steal information for criminal purposes (e.g., such as stealing a credit card number or bank account number to steal money).

Unlike outsiders who can be prevented from having any access to computer environments, insiders need to be given access to the environments to perform authorized tasks. For example, database administrators need to be given access to databases in order to maintain those databases. Likewise, users of programs need to be given access to the programs in order to use the programs.

Existing technologies attempt to monitor activities of such insiders by providing access restrictions and logging capabilities. These access restrictions and logging capabilities are provided at the database and/or program level rather than at a level which protects an entire computer environment.

Accordingly, new mechanisms for monitoring access to computer environments are desirable.

### SUMMARY

Methods, media, and systems for monitoring access to computer environments are provided. In some embodiments, methods for monitoring access to a computer environment by a technician workstation are provided, the methods comprising: setting up a remote desktop access session between a hardware processor of a proxy and the technician workstation; connecting the remote desktop access session to the computer environment; providing access to the computer environment from the technician workstation using the remote desktop access session; recording remote desktop access messages; and replaying the remote desktop access messages.

In some embodiments, non-transitory computer-readable media containing computer-executable instructions that when executed by a. processor, cause the processor to perform a method for monitoring access to a computer environment by a technician workstation are provided, the method comprising: setting up a remote desktop access session between a hardware processor of a proxy and the technician workstation; connecting the remote desktop access session to the computer environment; providing access to the computer environment from the technician workstation using the remote desktop access session; recording remote desktop access messages; and replaying the remote desktop access messages.

In some embodiments, systems tor monitoring access to a computer environment by a technician workstation are provided, the systems comprising: at least one hardware processor that: sets up a remote desktop access session between a hardware processor of a proxy and the technician workstation; connects the remote desktop access session to the computer environment; provides access to the computer environment from the technician workstation using the remote desktop access session; records remote desktop access messages; and replays the remote desktop access messages.

### BRIEF DESCRIPTION OF THE DRAWINGS

FIG. 1 is a diagram of an example of an architecture for monitoring access by users of technician workstations to computer environments using multiple spokes in accordance with some embodiments.

FIG. 2 is a diagram of an example of a spoke for monitoring access by users of technician workstations to computer environments in accordance with some embodiments,

FIG. 3 is a diagram of examples of processes for a technician workstation, a capture agent and a virtual machine in accordance with some embodiments.

FIG. 4 is a diagram of examples of processes for an encoding agent and a cache agent in accordance with some embodiments.

FIG. 5 is a diagram of examples of processes for an optical, character recognition agent, an alert agent, and a file repository agent in accordance with some embodiments.

FIG. 6 is a diagram of an example of a process for a security oversight workstation Web page in accordance with some embodiments.

FIG. 7 is a diagram of a user interface for viewing a list of session in accordance with some embodiments.

FIG. 8 is a diagram of a user interface for viewing an active session in accordance with some embodiments.

FIG. 9 is a diagram of a user interface for viewing multiple active sessions in accordance with some embodiments.

FIG. 10 is a diagram of a user interface tor viewing a recorded session in accordance with some embodiments.

### DETAILED DESCRIPTION

Methods, media, and systems for monitoring access to computer environments are provided. In some embodiments, monitored access to a computer environment is provided to a technician workstation through a remote desktop access mechanism and a transfer file repository connected between the technician workstation and the computer environment. Remote desktop access messages (such as screen updates, remote frame buffers, etc.), keystroke inputs, mouse inputs, clipboard content, and transfer files sent between the technician workstation and the computer environment can then be recorded, observed in real time at a security oversight workstation, and automatically monitored for alert conditions based on keystroke inputs, mouse inputs, file content, and optical character recognition on the remote desktop access images. In this way, unauthorized activity of a user/technician at the technician workstation can be observed and recorded.

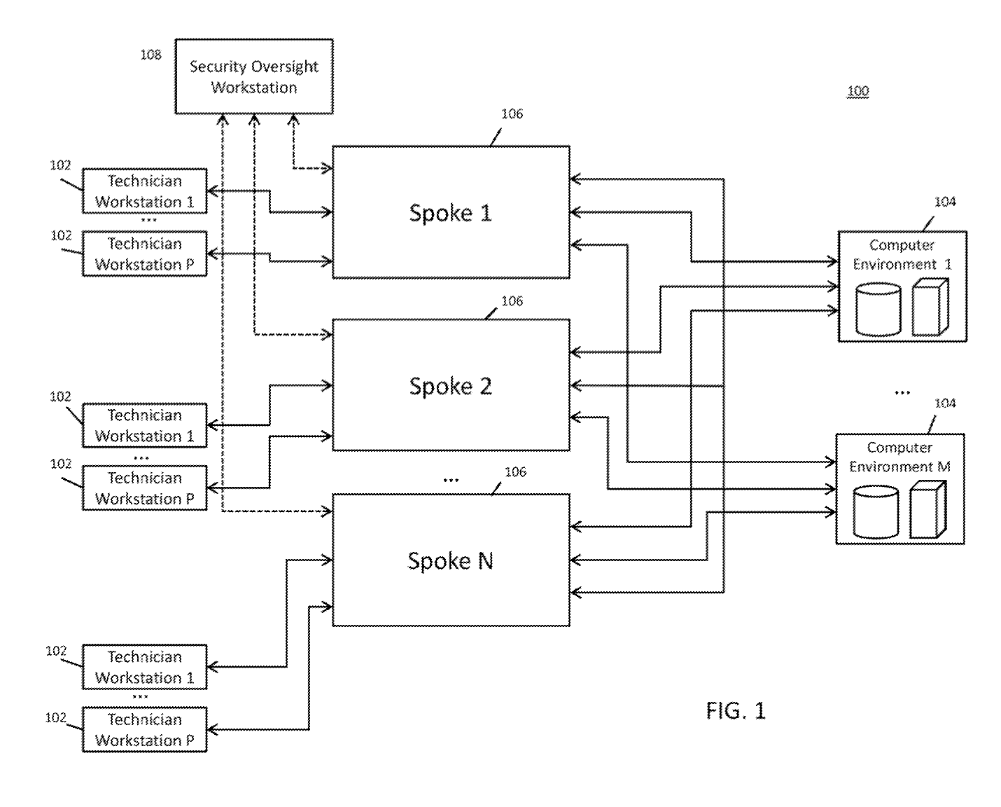

Turning to FIG. 1, an example of an architecture 100 for connecting technician workstations 102 to computer environments 104 in accordance with some embodiments is shown. Computer environments 104 can be any suitable environments (such as a computer data center) for housing devices such as computers, servers, databases, security systems, access control systems, email systems, groupware systems, collaboration systems, enterprise resource planning systems, etc. Technician workstations 102 can be any suitable devices, such as desktop computers, laptop computers, computer terminals, etc., for accessing devices housed in environments 104. Any suitable numbers, including one each, of technician workstations 102 and computer environments 104 can be used.

As illustrated, technician workstations 102 can be connected to computer environments 104 via proxies, such as spokes 106. Spokes 106 can provide mechanisms to monitor the activity of users/technicians using technician workstations 102 to access computer environments 104. Any suitable monitoring can be performed by spokes 106 in some embodiments. Security oversight workstations 108 can be used by security personnel to monitor the user/technician activity monitored by spokes 106. For example, workstations 108 can be used to observe live activity of the technicians, to receive alerts when certain activities are detected (as described further below), to control access to environments 104 by the users/technicians, etc. Any suitable numbers, including one each, of spokes 106 and security oversight workstations 108 can be used in some embodiments.

In some embodiments, each computer environment, spoke, security oversight workstation, and technician workstation can be owned by and/or under the control of any suitable one or more entities. For example, each computer environment can be owned by a different company, the spokes and security oversight workstation can be owned and operated by a security service provider, and the technician workstations can be owned and operated by an information technology outsourcing services provider, in some embodiments. Any other suitable arrangement of ownership, control, and/or operation of the components illustrated in FIG. 1 can additionally or alternatively be used in some embodiments.

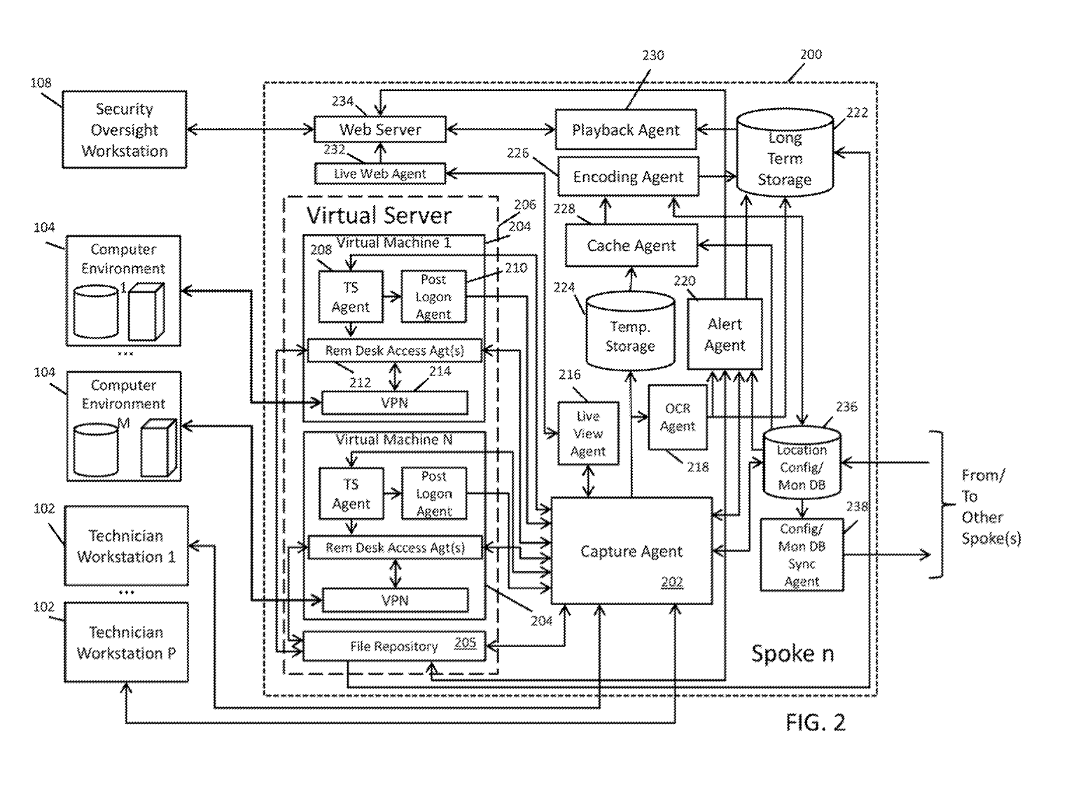

FIG. 2 illustrates an example of a spoke 200 that can be used as any one or more of spokes 102 of FIG. I in accordance with some embodiments. As shown, spoke 200 can include a capture agent 202 and virtual machines 204. Capture agent 202 and virtual machines 204 can be used to provide connections between technician workstations 102 and computer environments 104 and monitor those connections. As described more fully below, these connections can be facilitated by remote desktop access servers running in remote desktop access agents 212 of virtual machines 204. Any suitable remote desktop access servers, such as those provided with the Virtual Network Computing (VNC) application available from RealVNC Ltd. of Cambridgeshire, UK, Remote Desktop Sendees available from Microsoft Corporation of Redmond, Wash., Citrix XenApp available from Citric Systems of Fort Lauderdale, Fla. as well as remote text terminals such as open-source and proprietary implementations of SSH (Secure Shell) or Telnet protocols, can be used in some embodiments. Any suitable number (including only one) of virtual machines 204 running, in any suitable number (including only one) of virtual servers 206 can be used, in some embodiments. These remote desktop access servers can connect to computer environments 104 via a secure communication network connection, such as a virtual private network (VPN) provided by VPN mechanism 214, and to remote desktop access clients (such as VNC clients) on technician workstations 102 via screen update messages (such as remote frame buffers (RFBs) or any other suitable data transfer mechanism), keystroke messages, mouse input messages, and clipboard content, messages sent through, and recorded by, capture agent 202. Any suitable secure communication network connection mechanisms, such as VPN mechanisms including OpenSwan available from openswan.org, Cisco VPN Client, Cisco AnyConnect VPN Client, and/or Cisco ASA 5500 Servies devices available from Cisco Systems., Inc. of San Jose, Calif., can be used in some embodiments. Any suitable data transfer mechanism (such as RFBs, Remote Desktop Protocol (RDP) packets, etc.) encoded in any suitable format (e.g., such as raw, copyrect, hextile, cursor pseudo encodings, etc.) can be used in some embodiments.

In some embodiments, one or more file repository virtual machines 205 can be provided for enabling file transfer between a computer environment and a technician workstation. A file repository in the one or more file repository virtual, machines can be used to monitor and control files that are transferred to and/or from the computer environment. A user/technician can be restricted to using the file repository(ies) for transferring files to and/or from the computer environments. For example, in some embodiments, in order to transfer a file to a computer environment, a user/technician may first be required to place the file (e.g., via a drag and drop or command-line user interface) in an incoming, check-in folder of a file repository. A file repository agent may then copy the file to long term storage, note information about the transfer (e.g., by whom, when, etc,), send the file to the alert agent to determine whether the transfer should trigger an alert, be prevented, etc. (as described further below), and then move the file to an incoming, check-out folder in the file repository. The user/technician may then be able to complete the transfer to the computer environment by copying the file out of the incoming, check-out folder to the desired location in the computer environment. Likewise, in some embodiments, for example, in order to transfer a file from a computer environment, a user/technician may first be required to place the file (e.g., via a drag and drop or command-line user interface) in an outgoing, check-in folder of a file repository. A file repository agent may then copy the file to long term storage, note information about the transfer (e.g., by whom, when, etc.), send the file to the alert agent to determine whether the transfer should trigger an alert, be prevented, etc. (as described further below), and then move the file to an outgoing, check-out folder in the file repository. The user/technician may then be able to complete the transfer from the computer environment by copying the file out of the outgoing, check-out folder to the desired location.

While spoke 200 is described herein as including a virtual server 206 providing virtual machines 204 and 205, in some embodiments, one or more individual physical computers can be provided instead of or in addition to, virtual machines 204 and 205 for performing the functions described herein of virtual machines 204 and/or 205.

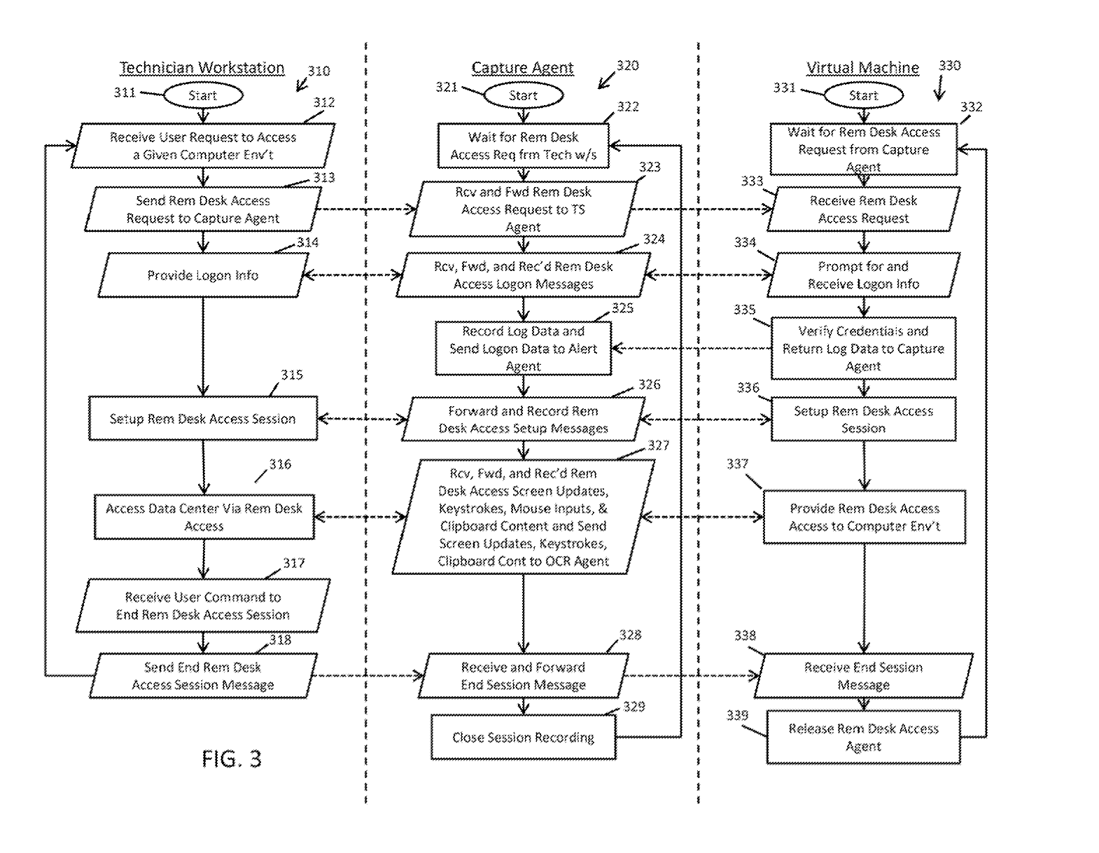

Turning to FIG. 3, examples of processes 310, 320, and 330 for technician workstations 102, capture agent 202, and virtual machines 204, respectively, in accordance with some embodiments are illustrated. As shown, after processes 310, 320, and 330 begin at 311, 321, and 331, respectively, process 310 can receive a user request to access a given computer environment at 312, process 320 can wait for a remote desktop access request from the technician workstation process at 322, and process 330 can wait for a remote desktop access request from the capture agent process at 332. After receiving the user request at 312, process 310 can send a remote desktop access request to the capture agent process at 313, this remote desktop access request can. be received and routed to the appropriate terminal server (TS) agent 208 (FIG. 2) of the virtual machine process at 323, and the remote desktop access request can be received by the TS agent of the virtual machine process at 333.

Next, at 334, the TS agent of process 330 can prompt for, and subsequently receive, logon information at 334, process 320 can receive, forward, and record remote desktop access logon messages between processes 310 and 330 at 324, and process 310 can receive the prompt message, present the prompt, receive from the user logon information, and provide that logon information to capture agent 320 at 314. Any suitable logon messages, such as user id. entered password, etc., can be recorded, and the logon messages can be recorded to any suitable storage mechanism, in accordance with some embodiments. For example, the logon messages can be recorded to temporary storage 224 (FIG. 2) (which can be a local disk cache, memory, or any other suitable storage in some embodiments) and/or to a live view agent 216 (FIG. 2) for subsequent processing as described below.

The TS agent of process 330 can then verify the user's logon credentials and return log data using a post-logon agent 210 (FIG. 2) of process 330 to the capture agent, at 335, and process 320 can receive and record that log data, and send, the logon information to alert agent 220 (FIG. 2), at 325. Any suitable log data, such as user id, user biometric data, return IP address and port, information about the used technician workstation 102, a time stamp, an identifier of program being used, an identifier of a physical network source (e.g., VPN tunnel, etc.) and/or any other suitable information, can be recorded in some embodiments, and the log data can be recorded to any suitable storage mechanism. For example, the log data can be recorded to temporary storage 224 and/or to live view agent 216 for subsequent processing as described below.

Once the user has logged on, processes 310 and 330 can setup a remote desktop access session at 315 and 336, and process 320 can receive, forward, and record remote desktop access setup messages sent between process 310 and 330 at 326. In some embodiments, these setup messages can also be sent to optical character recognition (OCR) agent 218 (FIG. 2). Any suitable remote desktop access setup messages, such as messages for specifying desktop dimensions, title, color depth, and any other suitable characteristics, can be recorded in some embodiments, and the setup messages can be recorded to any suitable storage mechanism. For example, the setup messages can be recorded to temporary storage 224 and/or to live view agent 236 for subsequent processing as described be Sow.

Next, at 316, 327, and 337, remote desktop access can be effected between processes 310 and 330, and screen updates (as described in desktop sharing RFBs, for example), keystrokes, and mouse inputs sent between these processes can be received, forwarded, and recorded, and these screen updates and keystrokes sent to OCR agent 218 by process 320. Any suitable screen updates, keystrokes, and/or mouse inputs can be recorded in some embodiments, and the screen updates, keystrokes, and/or mouse inputs can be recorded to any suitable storage mechanism. For example, the screen updates, keystrokes, and/or mouse inputs can be recorded to temporary storage 224 and/or to live view agent 216 for subsequent processing as described below.

In some embodiments, if a user copies, cuts, and/or pastes content from/to the session, that content can be passed between clipboards of the technician workstation and the virtual machine via the capture agent. Like screen updates, keystrokes, and/or mouse inputs, this content can be received, forwarded, and recorded at 327 by the capture agent, and the content sent to the OCR agent.

When the remote desktop access session is to be terminated, process 310 can receive a user command to end the remote desktop access session at 317. Process 310 can then send an end remote desktop access session message to the capture agent process at 318 and loop back to 312 to wait for the next user request to access a given computer environment. Capture agent process 320 can then receive and forward to virtual machine process 330 the end session message at 328 and process 330 can receive this message at 338. Finally, at 329 and 339, process 320 can close the session recording and process 330 can release the remote desktop access agent, respectively, and these processes can loop back to 322 and 332, respectively, to wait for another remote desktop access request.

As described above, in accordance with some embodiments, screen updates can be recorded by the capture agent to temporary storage 224 of FIG. 2. Once a session has been recorded, the session can be encoded for subsequent playback. This encoding can include indexing in some embodiments. This encoding can be facilitated by an encoding agent 226 and a cache encoding agent 228 as shown in FIG. 2.

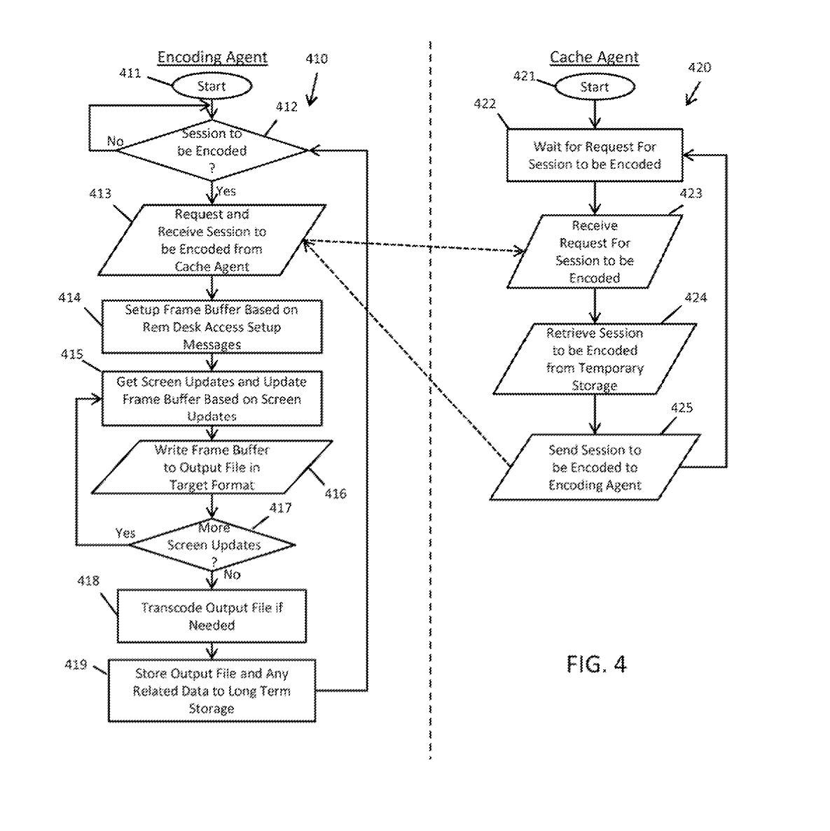

Examples of processes 410 and 420 that can be used in encoding agent 226 and cache agent 228 in accordance with some embodiments are shown in FIG. 4. As illustrated, after processes 410 and 420 begin at 411 and 421, respectively, process 410 can determine at 412 if there is a session to be encoded and process 420 can wait for a request for a session to be encoded at 422, Any suitable criterion or criteria cars be used to make this determination, in some embodiments. For example, the determination can be based on whether a. session's recording was recently closed (e.g., as performed at 329 of FIG. 3) in some embodiments. If there is no session to be encoded, process 410 can loop back, to 4.12. Otherwise process 410 can next request and subsequently receive a session to be encoded from cache agent process 420. In response, this request can be received by cache agent process 420 at 423, after which process 420 can retrieve the session from temporary storage 224 (FIG. 2) at 424, send the session to encoding agent process 410 at 425, and loop back to 422.

Next, at 414, process 410 can set up a frame buffer based on the remote desktop access setup messages recorded for the session. For example, the frame buffer can be setup to match the screen size and pixel format of the session in accordance with some embodiments.

Then, at. 416, process 410 can get a screen update and update the frame buffer based on the screen update. The frame buffer can then be written to an output file in a target format in long term storage 222 (FIG. 2). Any suitable output file in any suitable target format can be used in some embodiments. Any suitable long term storage, such as a disk drive, solid state memory, etc., can be used in some embodiments.

In accordance with some embodiments, the encoding agent can use two or more frame rates, The first frame rate can be the regular frame rate (e.g., 10 frames per second) and the other frame rate(s) can be for times when the frame rate is slowed down (e.g., to one frame per second) during points of low activity. When there is no change in the frame buffer, multiple copies of the same frame can be written to the output file in order to achieve the desired frame rate in some embodiments.

In some embodiments, the output file can include multiple frame rates and the playback of this output file can be played back at a constant, high frame rate so that, during periods of low activity, the playback of this output file effectively speeds up and then slows down during periods of normal and high activity. Additionally or alternatively, playback of an output file can include determining the level of activity in the recorded content and changing the speed of playback so that periods of low activity are played back at higher speeds than periods of high or normal activity. This can be the case irrespective of whether the output file is recorded with only one or more than one frame rate.

In some embodiments, small changes, such as a blinking cursor, a blinking “:” in a clock time (e.g., “12:00”), etc., can be ignored so as to allow the frame rate to be reduced during periods of otherwise-low activity.

At 417, process 410 can then determine if there are more screen updates to process. If so, the process can loop back to 415. Otherwise, process 410 can then transcode the output file to another format at 418 if needed.

In some embodiments, the output file can be transcoded using a series of transcoding. For example, the output file can start out in portable pixmap format (PPM) as written at 416. The output file can then be transcoded into the y4.m format. The output file can then be transcoded to the Theora format Although specific formats are described herein, any suitable video encoding formats and any suitable numbers of formats (including only one) can be used in some embodiments.

In some embodiments, the output file can be encrypted. Any suitable encryption technique can be used in some embodiments.

Finally, at 419, process 410 can store the output file and any related data to the long term storage and then loop back to 412.

As described above, screen updates and keystrokes can be provided by capture agent 202 (FIG. 2) to OCR agent 218 (FIG. 2) in accordance with some embodiments. The OCR agent can be used to perform optical character recognition on the remote desktop access screen updates to extract text that is only in image format in the screen updates. This text, along with the keystrokes received at the screen updates, can then be provided to alert agent 220 (FIG. 2) that can determine if an action should be taken based on the text on the remote desktop and corresponding keystrokes. A file repository agent in file repository 205 can similarly provide files to alert agent 220 to determine whether action should be taken in response to an attempted file transfer.

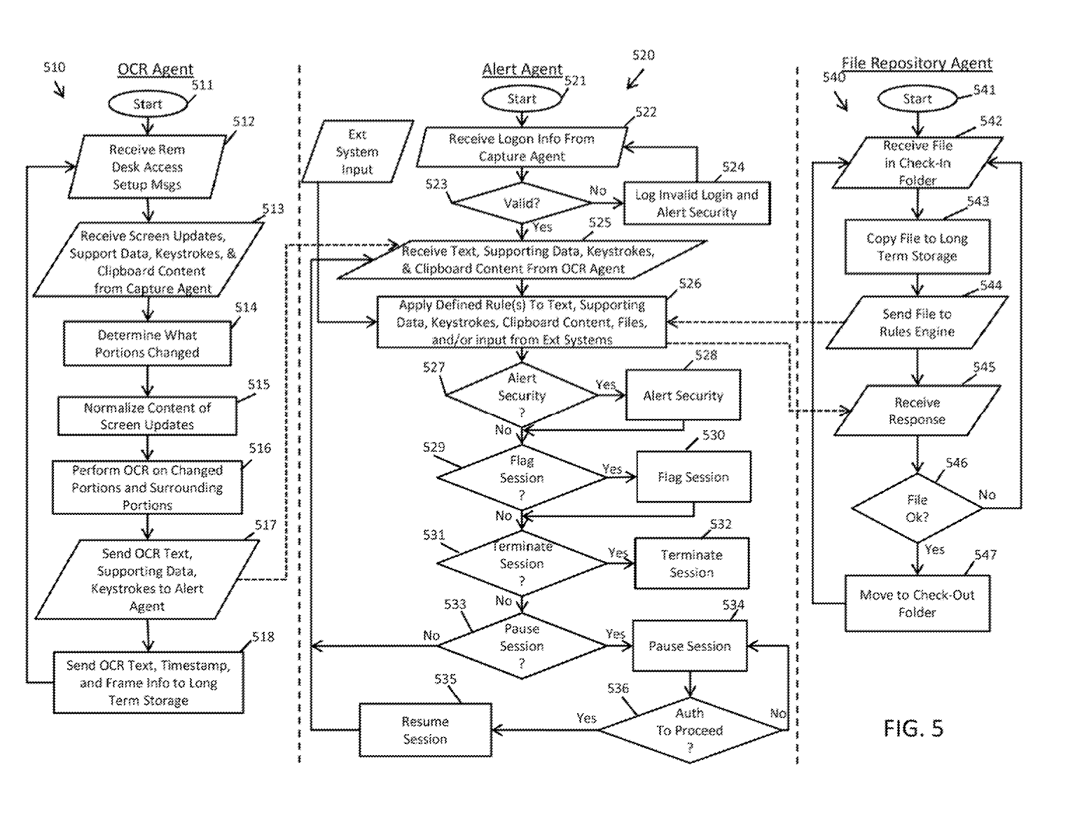

Examples of processes 510, 520, and 540 that can be used in OCR agent 218, alert agent 220, and a file repository agent of file repository 205 in accordance with some embodiments are illustrated in FIG. 5. As shown, after processes 510 begins at 511, process 510 can receive remote desktop access setup messages for a remote desktop access session at 512. These messages can be used to set up a frame butler for subsequently received screen updates. Next, at 513, process 510 can receive a screen update, supporting data, corresponding keystrokes, and/or clipboard content from the capture agent process. This screen update can then be analyzed to determine what portions of the remote desktop changed at 514. The changed portions and surround portions (if desired) can be processed (such as by normalization, color removal, etc.) to remove features that may impact optical character recognition at 515. Then, at 516, optical character recognition can be perforated on the changed portions and surrounding portions (If desired). At 516, optical character recognition can additionally or alternatively be performed on graphical clipboard content in some embodiments. Any suitable technique for performing optical character recognition can be performed in accordance with some embodiments. This optical character recognition on the screen updates and/or graphical clipboard content can produce optical character recognition text. Next, the optical character recognition text, supporting data, and corresponding keystrokes can be sent to alert agent process 520 at 517. Finally, the optical character recognition text, a timestamp, frame information, and/or any other suitable data can be sent to long term storage 222 (FIG. 2) at 518 and process 510 can loop back to 512. This data can subsequently be used to keep track of tasks that have been performed by technicians (e.g., in response to outstanding work tickets), can be used to support billing for outsourced technicians, and can be used to facilitate future trouble shooting of solved problems containing the same text.

After process 520 begins at 521, the process receives logon information from the capture agent process at 522. Next, the process determines at 523 if the logon is valid. Any suitable mechanism can be used to determine if the logon is valid. For example, the logon information can include information from virtual machine 204 (FIG. 2) indicating if the logon is valid, if the logon is determined to be invalid, then process 520 can log the invalid login (and any suitable corresponding data) in long term storage 222 (FIG. 2) and loop back to 522, Otherwise, process 520 can wait for and receive text, supporting data, keystrokes, and clipboard content from OCR agent process 510 at 525.

Next, at 526, process 520 can apply one or more defined rule(s) to the text, supporting data, keystrokes, clipboard content, files (received from process 540 as described below), and/or inputs from external systems (as described below) at 526. Any suitable rules, and any suitable number (including one) of rules can be used in some embodiments. For example, a rule may define that certain action (e.g., such as generating an alert, flagging a session, terminating a

session, pausing a session, etc.) should be taken when certain text (e.g., such as “confidential,” account numbers, credit card numbers, social security numbers, passwords, personal identification numbers (pins), etc.) is present on the remote desktop. The process can then determine if an alert to security should be generated at 527, and if so, alert security at 528. Next, the process can determine if the session should be flagged at 529, and if so, flag the session at 530. The process can next determine if the session should be terminated at 531, and if so, terminate the session at 532, Then, the process can determine at 533 if the session should be paused, and if so, pause the session at 534, loop between 536 and 534 until, authorization to proceed is received (e.g., from security personnel), and resume the session at 535, Finally, process 520 can loop back to 525.

After process 540 begins at 541, the process can receive a file in a check-in folder at 542, This folder can be an incoming or an outgoing check-in folder. The file can then be copied to long term storage in some embodiments at 543. Next, the file can be sent to the rules engine of the alert agent at 544 so that rules (like those described above, for example) can be applied to the file at 526. At 545, a response on the application of the rules to the file can be received from the rules engine. The process can then determine whether the file is OK to be transferred at 546. The file can be determined as being OK if it does not contain any confidential information, the user/technician is authorized to transfer this file, etc., for example, if the file is determined to be OK, then the file can be copied to the corresponding check-out folder at 547. After copying the file at 547, or if it is determined that the file is not OK at 546, then process 540 can loop back to 542.

In some embodiments, as described above, the rules applied at 526 can be responsive to inputs from external systems. Any suitable external systems, such as intrusion prevention systems, intrusion detection systems, self-learning alarm systems, etc., can be used in some embodiments. In this way. such inputs can be used to trigger an alert, flag a session, terminate a session, pause a session, etc. For example, if an Intrusion Prevention System or Intrusion Detection System has detected unauthorized activity that could be the result of activities performed by a user/technician, a signal can be sent to the alert agent so that an alert is raised that can lead to session termination, flagging of the session for the review, authorization request to security officer to continue, etc. As another example, self-learning alarm algorithms can analyze previously monitored sessions and be trained to automatically flag suspicious new sessions. The learning mechanisms can be based on: previously flagged sessions for review, including sessions manually flagged by security officer; actions that, in some instances, required additional authorization in the past; previous searches used for an audit of the recordings, etc.; keywords found via optical character recognition (OCR); etc.

In some instances, certain rules can be disabled for certain users/technicians and/or at certain times to facilitate activities that might otherwise generate an alert.

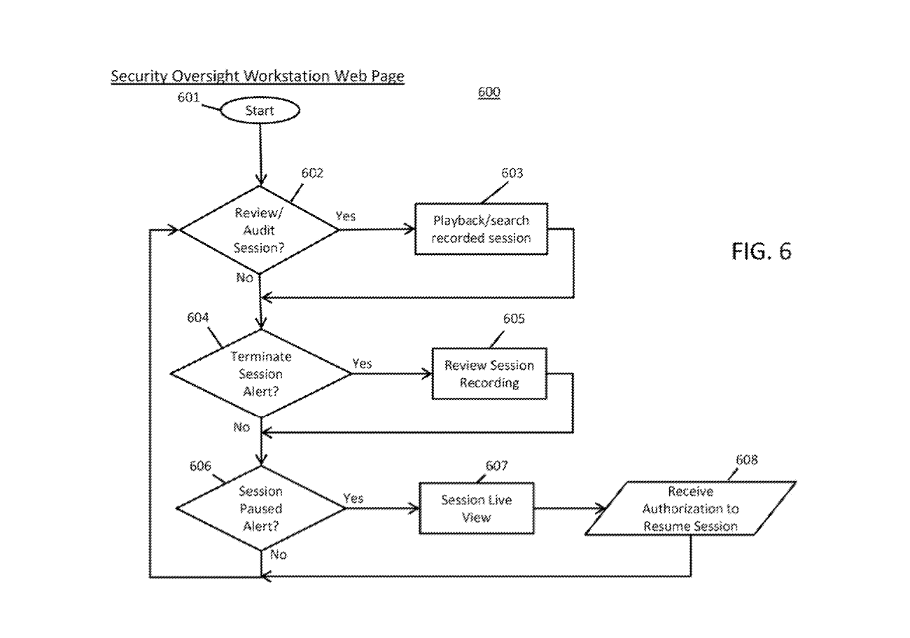

Turning to FIG. 6, a process 600 that can be presented to a security oversight workstation 108 via Web server 234 (FIG. 2) in accordance with some embodiments is illustrated. As shown, after process 600 begins at 601, the process can determine whether a security person at the workstation wants to review/audit a session at 602. If so, the process can then playback/search a recorded session at 603. Playback/searching of a recorded session can be performed in any suitable manner. For example, the Web server can receive a selection of a session and/or search parameters for a session, provide the selection, and/or parameters to playback agent 230 (FIG. 2), winch can retrieve the corresponding session, from long term storage 222 (FIG. 2), and present the session to the security person via Web server 234, Any suitable search parameters can be used. For example, the parameters can be used to search the content of the screen by keywords (e.g. command, database table name, etc.), by confidential information (e.g., credit card numbers, account numbers, etc.), etc. A security person can be provided with a list of options based on search results. For example, in some embodiments, a search can return a list of keyword occurrences on the security person's screen, and each occurrence can be identified by a timestamp and a frame number. As another example, in some embodiments, a search can return portions of video in which the keywords appeared and/or disappeared. The security person can then have the option to playback a corresponding video recording from the frame in which the keyword appears and/or disappears.

Next, process 600 can determine whether a session has been automatically terminated by the rules engine at 604. if so, a recording of the session can be presented to a security person at a security oversight workstation at 605. The session can be presented by the playback agent retrieving the session from long term storage 222 and presenting the session to the security person via Web server 234.

At 606, process 600 can next determine whether an. active session was automatically paused by the rules engine at 606. If it is determined that a session was paused, the process can present a live view of the paused session at 607 and wait for authorization to resume the session to be received from the security oversight workstation at 608. Any suitable mechanism can be

used to provide a live view of an active session to the security person. For example, in some embodiments, remote desktop access setup messages, screen updates, keystrokes, and mouse inputs received by live view agent 216 (FIG. 2) can be provided to live Web agent 232 (FIG. 2), which can setup a frame buffer based on the setup messages, process screen updates, keystrokes, and mouse inputs, and generate a display of the active session to the security person via Web server 234.

Finally, process 600 can loop back to 602,

As illustrated in FIG. 2, a local configuration, and monitoring database 236 can be provided in a spoke 200 in accordance with some embodiments. This database can be used to store any suitable settings, rides, etc. for the node, such as desktop sharing configuration settings, alert rules, security personnel information, encoding settings, etc. These settings, rules, etc. can be synchronized with other databases 236 in other spokes through synchronization, agent 238 in some embodiments.

In accordance with some embodiments, multiple instances of the process illustrated in FIGS. 3-6, and/or any additional and/or alternative processes, can be executed to facilitate responding to multiple requests to access computer environments, simultaneous encoding of multiple sessions, performing simultaneous optical character recognition, monitoring for alerts on multiple sessions, multiple security oversight workstation Web page requests, etc.

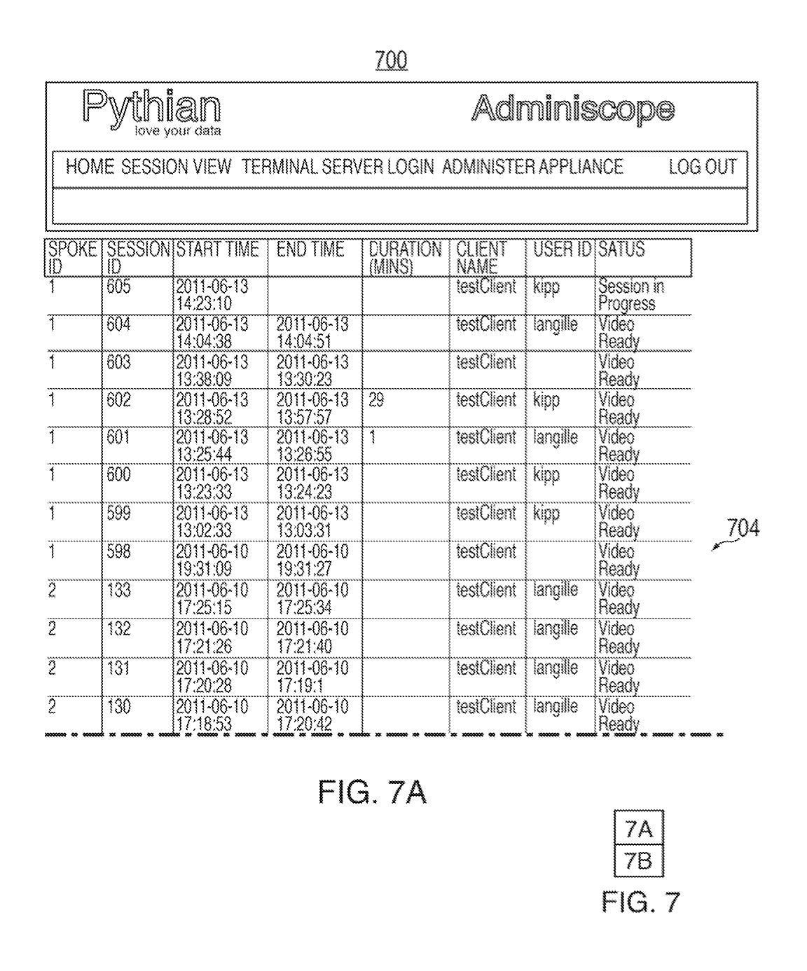

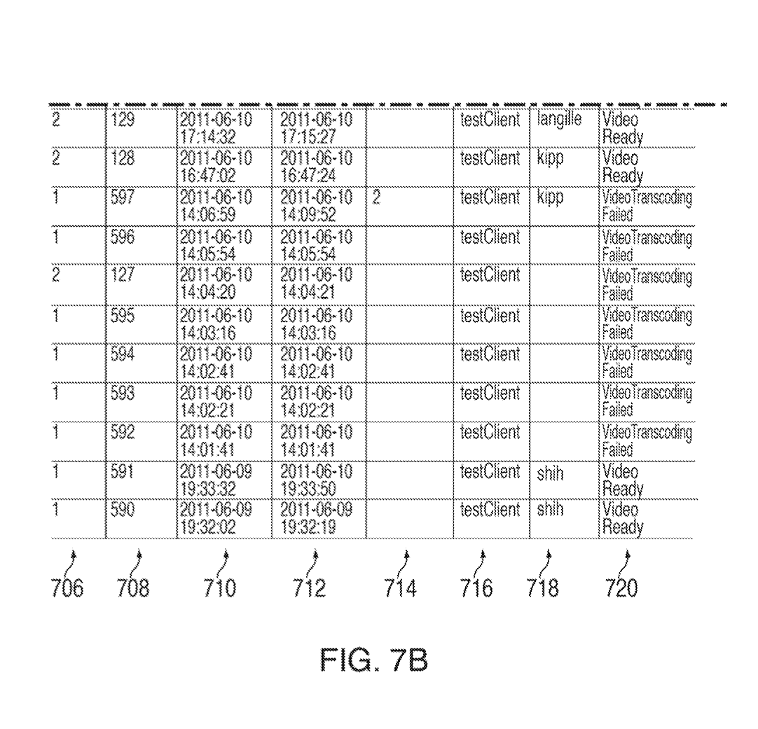

FIGS. 7-10 are examples of user interfaces that can be presented in accordance with some embodiments.

Turning to FIG. 7, an example of a user interface 700 for use at a security oversight workstation is illustrated. As shown, using this interface, a security person can see a list of sessions 704. This list can include, for example, a spoke identifier 706, a session identifier 708, a session start time 710, a session end time 712, a session duration 714, a client name 716 corresponding to the session, a user identifier 718 of a user/technician using the session, and a status 720 of the session. As can be seen, the status can indicate whether the session is in progress, whether an encoding of the session by encoding agent 226 (FIG. 2) has completed successfully as indicated by “video ready,” whether video transcoding was unsuccessful, etc.

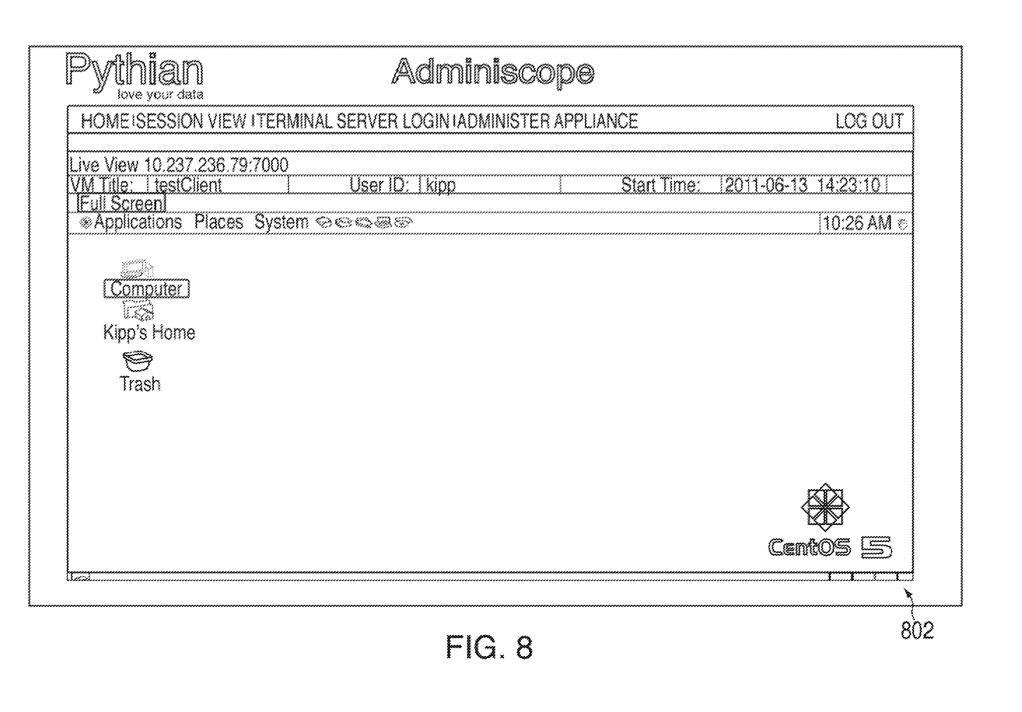

If a security person selects a session that is in progress, a user interface showing the active session may then be presented. An example of a user interface 800 with an active session is shown in FIG. 8. As illustrated, the session window seen by the user/technician of the session can be presented to the security person as sub-window 802.

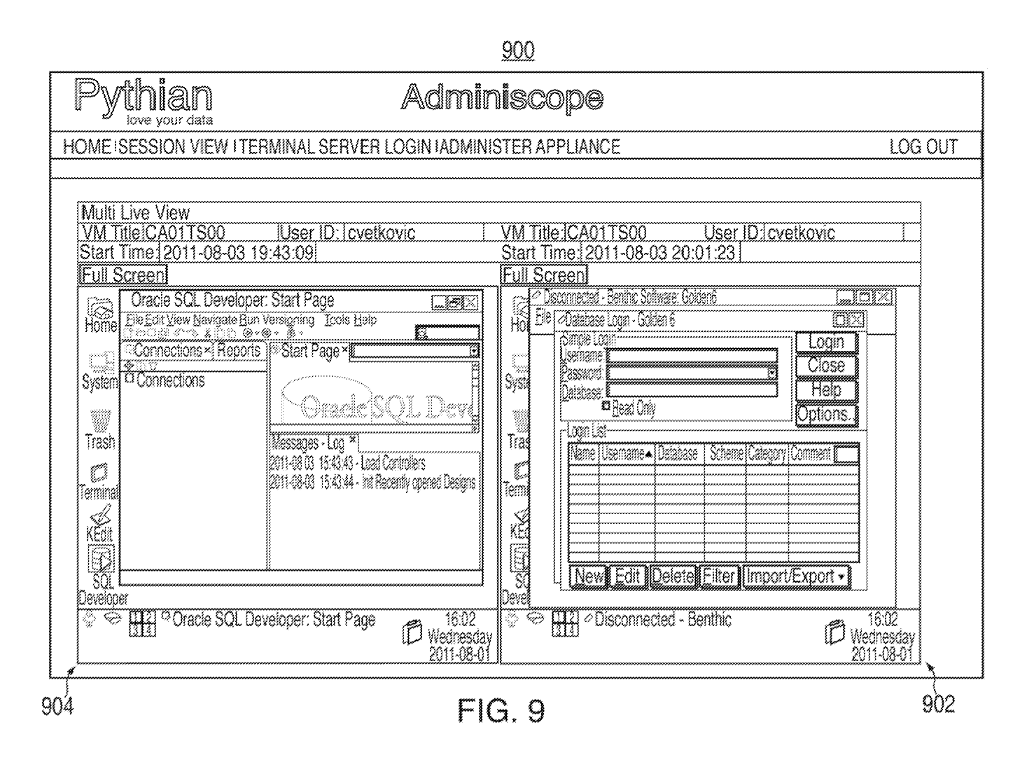

If a security person selects multiple sessions that are in progress, a user interface showing multiple active sessions may be presented. An example of a user interface 900 with, multiple active sessions is shown in FIG. 9. As illustrated, the session windows seen by two users/technicians can be presented to the security person as two sub-windows 902 and 904.

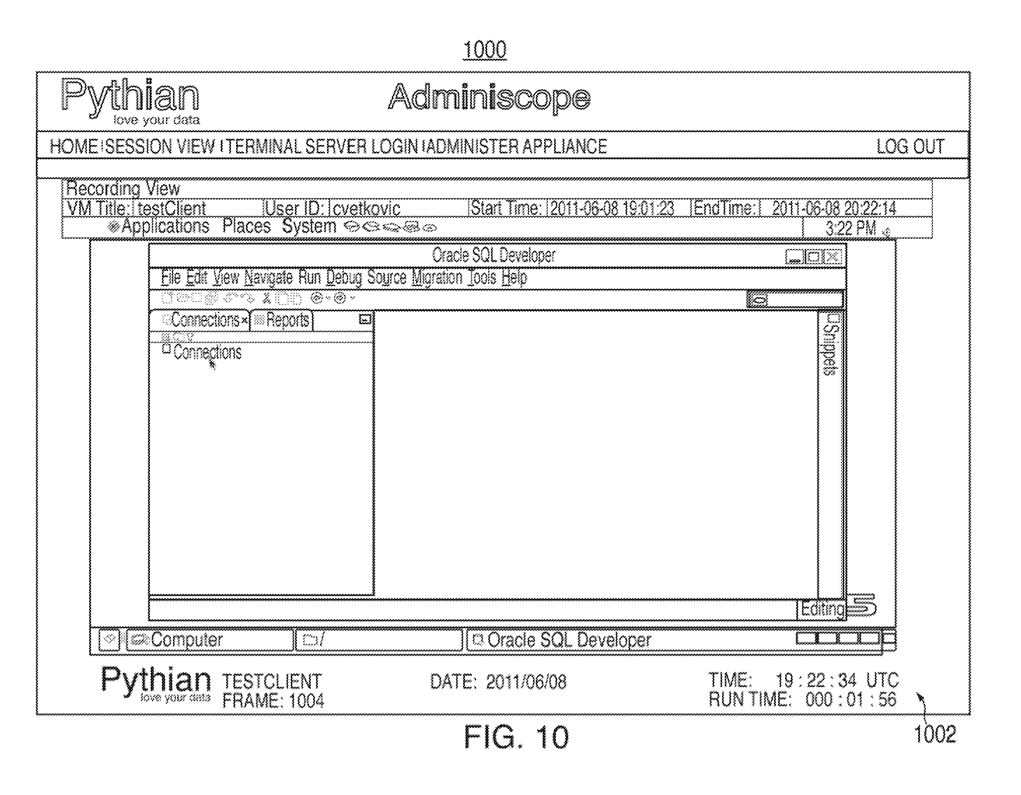

If a security person selects a session that has been encoded and is ready to be viewed, a user interface showing the recorded session may then be presented. An example of a user interface 1000 with a recorded session is shown in FIG. 10. As illustrated, the session window that was seen by the user/technician during the session can be presented to the security person as sub-window 1002.

In accordance with some embodiments, any one or more of the technician workstations, computer environments, spokes, and/or security oversight workstations can be any one or more of a general purpose device such as a computer or a special purpose device such as a client, a server, database, tablet, mobile device, etc. Any of these general or special purpose devices can include any suitable components such as one or more hardware processor (each of which can be a microprocessor, digital signal processor, a controller, etc.), memory, communication interfaces, display controllers, input devices, etc. For example, technician workstations and/or security oversight workstations can be implemented as a personal computer, a personal data assistant (PDA), a portable email device, a multimedia terminal, a mobile telephone, a smart phone, a set-top box, a television, etc.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A method for monitoring access to a computer environment by a technician workstation, comprising:
setting up a remote desktop access session between a hardware processor of a proxy and the technician workstation;
connecting the remote desktop access session to the computer environment;
providing access to the computer environment from the technician workstation using the remote desktop access session;
recording remote desktop access messages; and
replaying the remote desktop access messages,

2. The method of claim 1, wherein the remote desktop access session is a VNC session.

3. The method of claim 1, wherein the computer environment is a data center.

4. The method of claim 1, wherein the remote desktop access messages are remote frame buffers.

5. The method of claim 1, further comprising performing optical character recognition, on the remote desktop access messages to provide text.

6. The method of claim 5, farther comprising applying rules to the text and performing at least one of generating an alert, flagging the remote desktop access session, terminating the remote desktop access session, and terminating the remote desktop access session.

7. The method of claim 1, further comprising applying rules to an external input and performing at least one of generating an alert, flagging the remote desktop access session, terminating the remote desktop access session, and terminating the remote desktop access session.

8. The method of claim 1, further comprising providing a real-time view of the remote desktop access session at a security oversight workstation.

9. A non-transitory computer-readable medium containing computer-executable instructions that, when executed by a processor, cause the processor to perform a method for monitoring access to a computer environment by a technician workstation, the method comprising:
setting up a remote desktop access session between a hardware processor of a proxy and the technician workstation;
connecting the remote desktop access session to the computer environment;
providing access to the computer environment from the technician workstation using the remote desktop access session;
recording remote desktop access messages; and
replaying the remote desktop access messages.

10. The non-transitory computer-readable medium of claim 9, wherein the remote desktop access session is a VNC session.

11. The non-transitory computer-readable medium of claim 9, wherein the computer environment is a data center.

12. The non-transitory computer-readable medium of claim 9, wherein the remote desktop access messages are remote frame buffers.

13. The non-transitory computer-readable medium of claim 1, the method further comprising performing optical character recognition on the remote desktop access messages to provide text.

14. The non-transitory computer-readable medium of claim 13, the method further comprising applying rules to the text and performing at least one of generating an alert, flagging the remote desktop access session, terminating the remote desktop access session, and terminating the remote desktop access session.

15. The non-transitory computer-readable medium of claim 1, the further comprising applying rules to an external input and performing at least one of generating an alert, flagging the remote desktop access session, terminating the remote desktop access session, and terminating the remote desktop access session.

16. The non-transitory computer-readable medium of claim 1, the method further comprising providing a real-time view of the remote desktop access session at a security oversight workstation.

17. A system for monitoring access to a computer environment by a technician workstation, comprising:
at least one hardware processor that:
sets up a remote desktop access session between a hardware processor of a proxy and the technician workstation;
connects the remote desktop access session to the computer environment;
provides access to the computer environment from the technician workstation using the remote desktop access session;
records remote desktop access messages; and
replays the remote desktop access messages.

18. The system of claim 17, wherein the remote desktop access session is a VNC session.

19. The system of claim 17, wherein the computer environment is a data center.

20. The system of claim 17, wherein the remote desktop access messages are remote frame buffers.

21. The system of claim 17, wherein the at least one hardware processor also performs optical character recognition on the remote desktop access messages to provide text.

22. The system of claim 21, wherein the at least one hardware processor also applies rules to the text and. performs at least one of generating an alert, flagging the remote desktop access session, terminating the remote desktop access session, and terminating the remote desktop access session.

23. The system of claim 17, wherein the at least one hardware processor also applies rules to an external input and performs at least one of generating an alert, flagging the remote desktop access session, terminating the remote desktop access session, and terminating the remote desktop access session.

24. The system of claim 17, wherein the at least one hardware processor also provides a real-time view of the remote desktop access session at a security oversight workstation.
